(19) United States
(12) Patent Application Publication
(10) Pub. No.: US 2016/0271003 A1
(43) Pub. Date: Sep. 22, 2016

(54) Body Scratching Device

(71) Applicant: Verdell Duncan, Arkadelphia, AR (US)

(72) Inventor: Verdell Duncan, Arkadelphia, AR (US)

(21) Appl. No.: 15/069,394

(22) Filed: Mar. 14, 2016

Related U.S. Application Data
(60) Provisional application No. 62/133,550, filed on Mar. 16, 2015.

(51) Int. Cl. A61H 7/00

(52) U.S. Cl. CPC A61H 7/003

(57) ABSTRACT

A hand-held body scratching device for allowing a user to easily scratch a portion of the user's body. The body scratching device includes an elongated strap that is preferably composed of a flexible, fabric material. The elongated strap includes a first end and a second end, wherein each end includes a handle thereon for the user to grasp. A front surface of the body scratching device includes nodules thereon that can be placed against a user's back or other body part for use in scratching the desired portion of the user's body. The nodules preferably have a rounded configuration. In operation, the user can hold a handle in each hand and can place the front surface having nodules thereon against a portion of his or her body. The user can then maneuver the strap back and forth in order to scratch a portion of his or her body.

### CROSS REFERENCE TO RELATED APPLICATION

This application claims the benefit of U.S. Provisional Application No. 62/133,550 filed on Mar. 16, 2015. The above identified patent application is herein incorporated by reference in its entirety to provide continuity of disclosure.

### BACKGROUND OF THE INVENTION

### Field of the Invention

The present invention relates to body scratching devices. More specifically, the present invention provides a body scratching device comprising a flexible, elongated strap having a first end and a second end wherein a handle is disposed on each end of the elongated strap. The strap further includes a plurality of nodules on a front surface thereof, wherein the nodules can be placed against a user's body, such as the user's back, to scratch the desired area.

Many people have difficulty scratching or washing certain portions of their bodies. Some people may lack sufficient flexibility to scratch or wash all portions of their body. In particular, many people have trouble reaching all areas of their back. The person may have to twist or contort their body in attempt to scratch a portion of their body, and the person may be entirely unable to reach certain spots. As a result, the person may be uncomfortable and may not be able to properly scratch the affected area.

Various back scratching devices are available that comprise an elongated arm having a pointed end. However, such a device is only able to scratch a very small area of the user's body and may be hard to maneuver. Further, such back scratching devices may be too sharp and can irritate or break the person's skin. Accordingly, a hand-held back scratching device that allows a user to easily scratch or scrub a larger portion of user's back or other area is desired.

Devices have been disclosed in the prior art that relate to back scratching and back scrubbing devices. These include devices that have been patented and published in patent application publications. These devices generally relate to back scratching or scrubbing devices having a body member, such as an elongated strap, cable, or mitt, wherein the body member includes bristles, a sponge, or a brush thereon, such as U.S. Pat. No. 1,473,315, U.S. Pat. No. 4,915,096, U.S. Pat. No. 6,849,055, U.S. Pat. No. 3,213,474, U.S. Pat. No. 5,509,164, and U.S. Pat. No. 3,936,198.

These prior art devices have several known drawbacks. The devices in the prior art fail to disclose a back scratching device comprising a plurality of nodules thereon, wherein the nodules are composed of a rigid or semi-rigid material. The present invention provides an elongated strap having a plurality of nodules thereon, wherein the nodules are used to provide pressure to a user's body in order to scrub or scratch a portion of the user's body. Devices in the prior art generally relate to back scratching devices having bristles or other similar features and fail to provide an elongated strap having a plurality of nodules thereon.

In light of the devices disclosed in the prior art, it is submitted that the present invention substantially diverges in design elements from the prior art and consequently it is clear that there is a need in the art for an improvement to existing back scratching devices. In this regard the instant invention substantially fulfills these needs.

### SUMMARY OF THE INVENTION

In view of the foregoing disadvantages inherent in the known types of back scratching devices now present in the prior art, the present invention provides a new back scratching device wherein the same can be utilized for providing convenience for the user when scratching or scrubbing hard to reach locations on the user's back.

It is therefore an object of the present invention to provide a new and improved back scratching device comprising an elongated strap having handles on opposing ends thereof, wherein the elongated strap can be moved in a back and forth motion against a user's back or limbs in order to scrub or scratch the same.

It is another object of the present invention to provide a back scratching device comprising an elongated strap having a plurality of nodules on a front surface thereof, wherein the nodules are adapted to scratch or scrub the user's back or limbs.

Another object of the present invention is to provide a back scratching device comprising a plurality of nodules on both the front and rear surfaces thereof.

Yet another object of the present invention is to provide a back scratching device comprising an elongated strap having a C-shaped handle on each end thereof to allow the user to easily grip and maneuver the back scratching device.

Another object of the present invention is to provide a back scratching device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front view of the back scratching device of the present invention.

FIG. 1B shows a rear view of the back scratching device of the present invention.

FIG. 2 shows a close-up view of the nodules of the back scratching device.

FIG. 3 shows a view of the back scratching device in use.

### DETAILED DESCRIPTION OF THE INVENTION

Reference is made herein to the attached drawings. Like reference numerals are used throughout the drawings to depict like or similar elements of the back scratching device. For the purposes of presenting a brief and clear description of the present invention, the preferred embodiment will be discussed as used for scratching or scrubbing hard to reach locations on the user's back or limbs. The figures are intended for representative purposes only and should not be considered to be limiting in any respect.

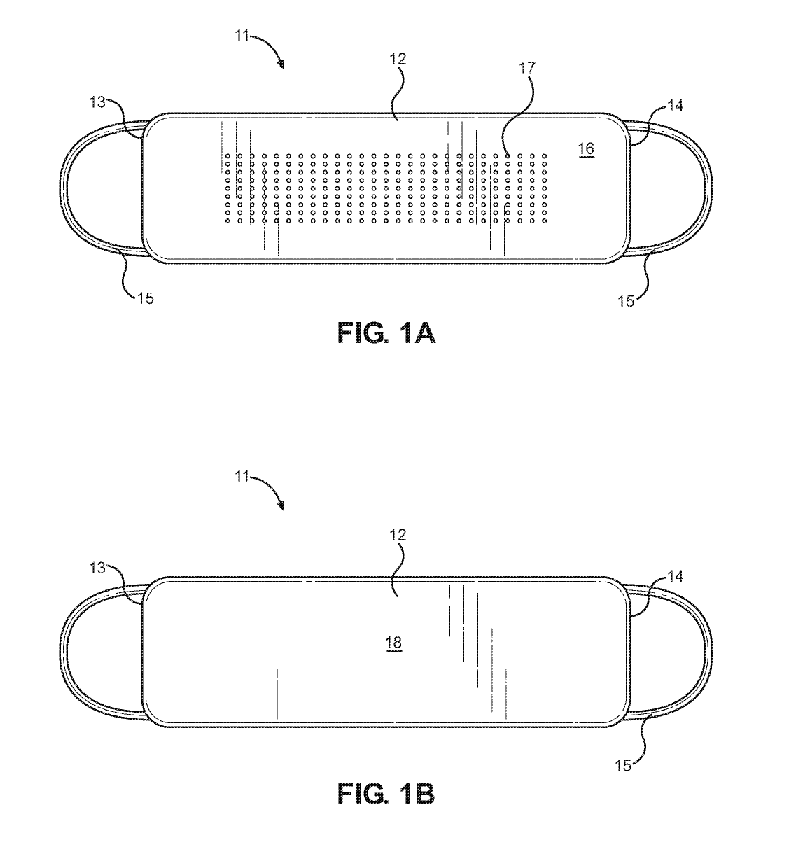

Referring now to FIGS. 1A and 1B, there are shown views of the front and rear of the back scratching device, respectively. The back scratching device 11 comprises an elongated strap 12 having a first end 13 and a second end 14. The elongated strap 12 preferably comprises a rectangular configuration, but may include other configurations in alternate embodiments. The elongated strap 12 is preferably composed of a flexible material, such as a fabric material. The elongated strap 12 may be composed of cotton, polyester, or leather, among other similar materials. In some embodiments, the elongated strap 12 is composed of an absorbent material so that it can be used to wash or scrub the user when soap and water are applied thereto.

Each of the first end 13 and second end 14 of the elongated strap 12 includes a handle 15 thereon. The handles 15 are preferably C-shaped and extend outwardly from the elongated strap 12. The handles 15 are composed of a flexible material. The handles 15 may be composed of the same material as the elongated strap 12. In some embodiments, the handles 15 include a grip thereon for allowing the user to more easily grasp the handles 15.

The front surface 16 of the elongated strap 12 comprises a plurality of nodules 17 thereon. The nodules 17 extend outwardly from the front surface 16 of the elongated strap 12. The nodules 17 are preferably semi-rigid and are adapted to contact the user's skin. The nodules 17 are preferably arranged in a grid on the front surface 16 of the elongated strap 12. Thus, the nodules 17 are arranged in rows and columns, and are spaced at a fixed intervals from one another. In this way, the user can engage the nodules 17 with his or her back, limb, or other body part, wherein the nodules 17 will scrub or scratch the user's body. In the illustrated embodiment shown in FIG. 1A, the nodules 17 are arranged centrally on the elongated strap, however in alternate embodiments the nodules 17 may be arranged on the entirety of the front surface 16. Furthermore, in alternate embodiments, the nodules 17 are additionally positioned on the rear surface 18 of the elongated strap 12 such that the user can utilize either side of the elongated strap 12 to scratch or scrub his or her body.

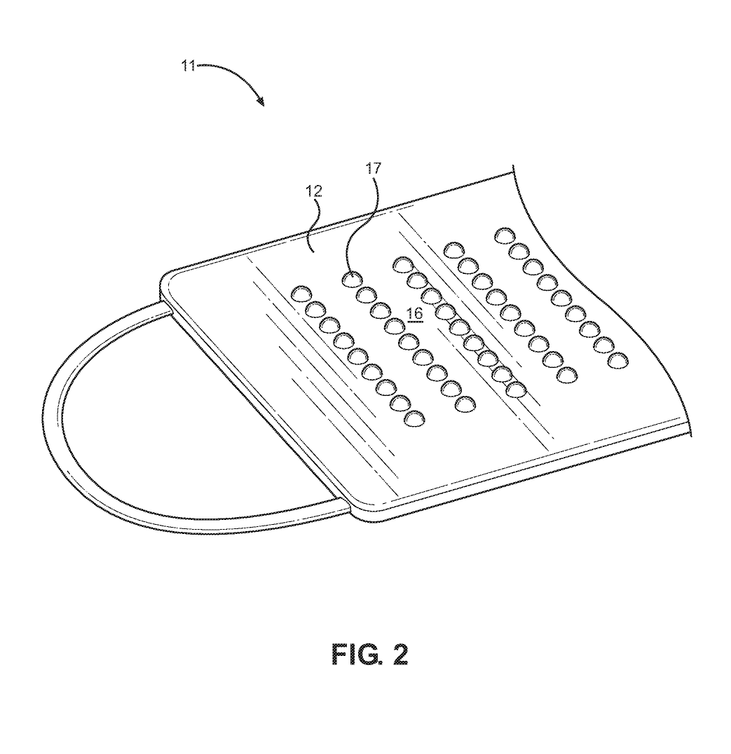

Referring now to FIG. 2, there is shown a close-up view of the nodules of the back scratching device. The nodules 17 on the elongated strap 12 extend outwardly from the front surface 16 thereof. In the illustrated embodiment, the nodules 17 comprises a rounded configuration. The rounded configuration allows the nodules 17 to be used to apply pressure on the user's back or limb, and the rounded shape prevents the user's skin from being broken or irritated from applying excessive pressure thereto. The nodules 17 are preferably hemispherical in configuration. However, in alternate embodiments, the nodules 17 may comprise alternate configurations, such as a pyramidal shape, so that the nodules 17 can be used to scratch the user's skin. Further, the nodules 17 are preferably composed of a semi-rigid material, such as rubber or silicone, among other similar materials. However, in alternate embodiments the nodules 17 are hollow or have a gel-filled interior volume.

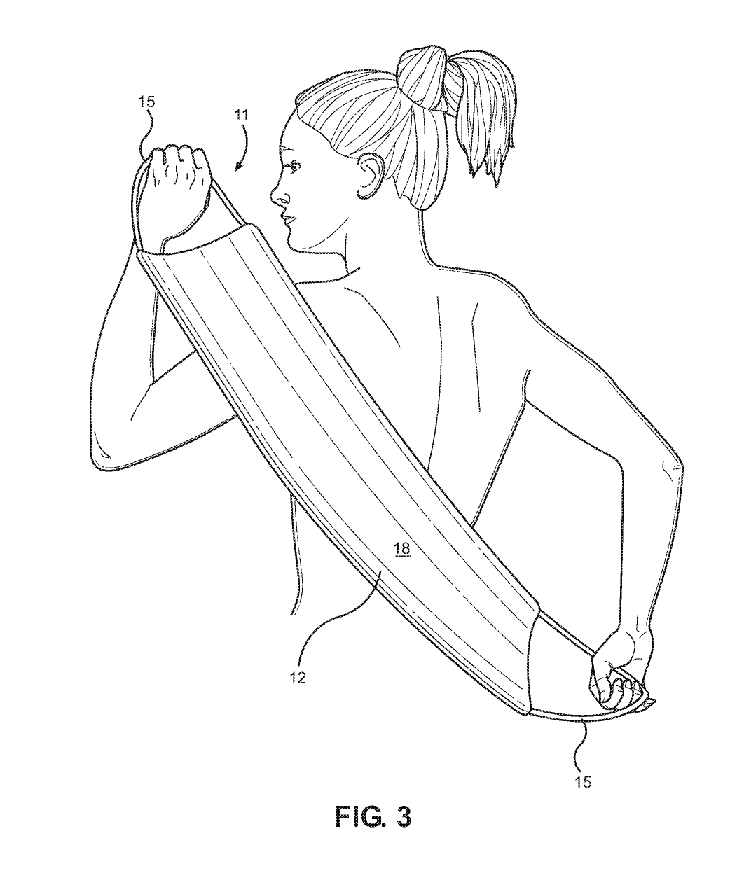

Referring now to FIG. 3, there is shown a view of the back scratching device in use. In operation, a user can grasp each handle 15 at opposing ends of the elongated strap 12 in each hand. The user can then position the elongated strap 12 against the user's back, limb, or other body part that the user wishes to scratch or scrub. The nodules on the elongated strap 12 can be placed in contact with the user's body. The user can then maneuver the back scratching device 11 in a back and forth motion so that the nodules move back and forth across the user's body. The elongated strap 12 provides a wide surface so that the user can scratch or scrub a relatively large portion of the user's body at a single time. In embodiments wherein the elongated strap 12 is composed of an absorbent material, the user can wet the elongated strap 12 and apply soap thereto in order to use the back scratching device 11 to wash the user's body.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A back scratching device, comprising:
an elongated strap having a first end, a second end, and a front surface;
a first handle disposed on said first end and a second handle disposed on said second end;
a plurality of nodules disposed on said front surface of said elongated strap.

2) The back scratching device of claim 1, wherein said elongated strap is flexible.

3) The back scratching device of claim 1, wherein said elongated strap is composed of an absorbent material.

4) The back scratching device of claim 1, wherein said first handle and said second handle are C-shaped.

5) The back scratching device of claim 1, wherein said plurality of nodules comprise a rounded configuration.

6) The back scratching device of claim 1, wherein said plurality of nodules comprise a hemispherical configuration.

7) The back scratching device of claim 1, wherein said plurality of nodules are arranged in a grid.

8) The back scratching device of claim 1, wherein said plurality of nodules are disposed on a rear surface of said elongated strap.
